(19) United States
(12) Patent Application Publication
(10) Pub. No.: US 2013/0177879 A1
(43) Pub. Date: Jul. 11, 2013

(54) WIRELESS PROCESSING SYSTEM AND METHOD

(71) Applicants: Barry J. Lipsky, Princeton Junction, NJ (US); Pang Lee, Tseung Kwan O (HK)

(72) Inventors: Barry J. Lipsky, Princeton Junction, NJ (US); Pang Lee, Tseung Kwan O (HK)

(73) Assignee: FRANKLIN ELECTRONIC PUBLISHERS, INCORPORATED, Burlington, NJ (US)

(21) Appl. No.: 13/346,791

(22) Filed: Jan. 10, 2012

(51) Int. Cl. G09B 7/00; H04B 3/00; G09B 19/02; H04Q 5/22

(52) U.S. Cl. 434/167; 340/10.1; 381/77; 434/188; 434/362

(57) ABSTRACT

A digital media device comprising an integrated circuit configured to send and receive content on receipt of a serial identification number unique to the personal digital media device, a processor and a display screen. The personal digital media device's processor utilizes a radio frequency integrated circuit to send and receive content with, for example, a personal computer or other host processing device.

### FIELD OF THE INVENTION

The present invention relates in general to personal digital media devices and in particular a personal digital media device that wirelessly interfaces with a computer or other host processing device, such as a tablet or smart phone, in order to send and receive content to and from the host processing device. The invention further relates to a method of providing application programs and content with a personal digital media device paired directly to a personal computer or other host processing device.

### BACKGROUND OF THE INVENTION

Various personal digital media devices are available for a variety of applications and uses. There exists a need in the art to provide learning content to a student in a manner that permits a supervisor, such as a teacher or a parent to assign, customize, and track the student's mastery of a given topic, such as spelling or mathematics. Often, the known devices ask questions in an audible format or display partially displayed words and prompt a student to supply the missing letters. Alternatively, the known devices may, for example, prompt a student to supply the sum, product or quotient of a given mathematical expression.

Several devices are known in the art to address this need, yet often, the known personal media devices have small display screens, limited data storage capacity and other limitations that make it difficult for adult supervisors to properly track a student's mastery of the learning content and lack the computing power to handle more processor-intensive calculations, such as speech recognition. Other personal digital media devices may attempt to solve this need by having larger display screens with high resolution, faster processers and additional data storage capacity, but these features add to the personal digital media device's cost.

A further need exists in the art to accommodate a plurality of personal digital media devices in circumstances in which a supervisor desires to assign and monitor a plurality of students, each student using their own personal digital media device. Ideally, a supervisor would be able to monitor one or more students in a real-time environment (or at some other time interval) from a personal computer in dynamic communication with one or more personal media devices. In so doing, a supervisor would be able to use a familiar operating system on a personal computer with a fast processor and ample data storage while one or more personal media devices could be paired to the personal computer with lower manufacturing costs than a personal digital media device incorporating a fast processor, high resolution display and ample data storage. Thus, it is with respect to these considerations and others that the present invention has been made.

### SUMMARY OF THE INVENTION

According to the present invention, the foregoing and other objects and advantages are obtained by utilizing a personal digital media device with an integrated circuit that is configured to send and receive digital signals with a host processing device upon the host processing device's receipt of a serial identification number unique to the personal digital media device which is transmitted by digital signals from the personal digital media device to the host processing device. A processor performs actions using the integrated circuit to send and receive digital signals. The processor also uses the integrated circuit to send and receive the serial identification number unique to the digital media device. The personal digital media device also has a display screen capable of displaying one or more lines of alphanumeric content.

According to another aspect of the invention, the integrated circuit is a radio frequency integrated circuit. According to another aspect of the invention, the display screen is capable of displaying between one and three lines of alphanumeric content. According to another aspect of the invention, the host processing device is a personal computer. According to another aspect of the invention, the digital signals comprise content. According to another aspect of the invention, the content comprises data sent from application software operating on a host processing device.

According to another aspect of the invention, the personal digital media device may include a speaker for broadcasting an audible signal or other sent content. The processor for the personal digital media device may be further adapted to receive data from a host processing device transmitted in the form of digital signals to the personal digital media device via the integrated circuit in the personal digital media device, such as a radio frequency integrated circuit, to signal the broadcast of an audible signal or sent content with the speaker.

The sent and received content can be, for example: (1) mathematical questions and answers; (2) spelling questions and answers; (3) general knowledge questions and answers; (4) logical operation questions and answers; and/or (5) a plurality of possible selections of which the user of the personal digital media device may select one of the possible selections which is subsequently sent and received as content.

According to another aspect of the invention, a system for communication between a host processing device and a personal digital media device can include a host processing device that is configured and programmed to perform actions. The actions include using a radio frequency integrated circuit that is configured to send and receive digital signals encoding content with a personal digital media device and a database file and file system to store and recognize a unique serial identification number corresponding to a personal digital media device where a unique serial identification number is transmitted as digital signals by the personal digital media device by radio frequency. The personal digital media device includes a radio frequency integrated circuit that is configured to send and receive digital signals encoding content with a host processing device and a unique serial identification number.

According to another aspect of the invention, the host processing device is a personal computer.

According to another aspect of the invention, a method of delivering content to a learner involves using a personal digital media device comprises the steps of pairing a personal digital media device and a host processing device by sending and receiving digital signals encoding content with radio frequency integrated circuits incorporated in the personal digital media device and the host processing device. A host processing device processor is adapted to recognize a unique serial number associated with one or more paired personal digital media devices within the range of the radio frequency receiver on the host processing device. A host processing device permits a host processing device user to label each recognized personal digital media device with a user-selected name corresponding to each unique serial number. Content encoded in digital signals is transmitted from the host processing device to each paired personal digital media device with the radio frequency integrated circuits incorporated in each paired personal digital media device and the host processing device. The paired personal digital media device user is provided with the content displayed on the paired personal digital media device and prompted to input a response to the content. The paired personal digital media device user's input in response to content is encoded in digital signals and transmitted to a paired host processing device with the radio frequency integrated circuits incorporated in the paired personal digital media device and the host processing device. The paired personal digital media device user's input is stored in a database file and file system on a computer readable medium. A programmed host processing device and a processor adapted to the host processing device's memory is used to compare the stored personal digital media device user's input to a correct input and to store information with respect to whether or not the user's input matches the correct input for the respective prompt in a database file and file system within the host processing device's mass memory.

According to another aspect of the invention, the host processing device is a personal computer. According to another aspect of the invention, the content is learning content.

According to another aspect of the invention, the programmed host processing device and the processor adapted to the host processing device's memory is used to utilize application software on the programmed host processing device, which is programmed and configured to: prepare reports summarizing a digital media device user's ratio of the number of inputs matching pre-determined correct inputs to the number of inputs not matching pre-determined correct inputs; send the said reports via e-mail to a designated recipient; make the said reports accessible on the host processing device; make the said reports accessible through any browser connected device; prepare summaries showing the percentage of content prompts for which the personal digital media device user has submitted input; send the said summaries via e-mail to a designated recipient; make the said summaries accessible on the host processing device; make the said summaries accessible through any browser connected device; and add, delete or modify the content sent by digital signals from the host processing device to the personal digital media device. According to another aspect of the invention, the said browser connected device comprises a personal computer other than the host processing device. According to another aspect of the invention, the said browser connected device comprises a tablet personal computer other than the host processing device. According to another aspect of the invention, the said browser connected device comprises a smart phone other than the host processing device.

### BRIEF DESCRIPTION OF THE DRAWINGS

The invention will become more readily apparent from the following description of preferred embodiments thereof shown, by way of example only, in the accompanying drawings wherein:

FIG. 1 shows a schematic diagram of one embodiment of a personal digital media device that may be employed;

FIG. 2 shows a functional block diagram illustrating an environment for practicing the invention; and

FIG. 3 is flow chart illustrating a system for carrying out one embodiment of the invention.

### DETAILED DESCRIPTION OF THE INVENTION

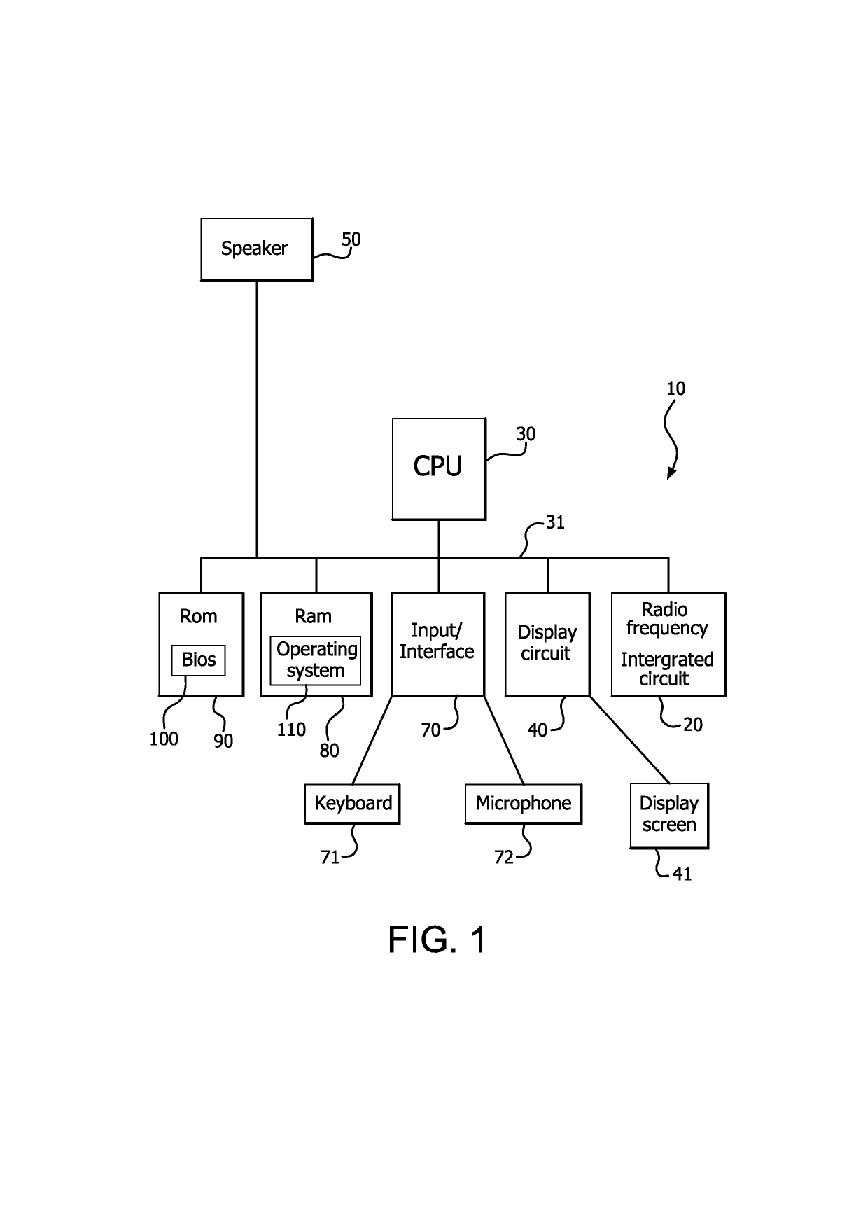

Referring to the drawings wherein like or similar references indicate like or similar elements throughout the several views, there is shown in FIG. 1 a schematic diagram of one embodiment of a personal digital media device that may be employed, generally identified by reference numeral 10. Central Processing Unit 30 (“CPU”) operates as the main control unit for the personal digital media device. The CPU 30 can be any microprocessor that is capable of being programmed to perform the various functions required by the personal digital media device. In a preferred embodiment, CPU 30 is a microcontroller unit with integrated RAM, ROM and I/O code and circuitry configured to perform the functions herein described. CPU 30 is programmed with the driver software necessary to control and enable each of the circuits connected to CPU 30. In addition, CPU 30 is programmed with application software to allow the user to perform functions on the database stored in the device. CPU 30 is electrically connected to and controls the other circuits in the personal digital media device via bus 31.

Display circuit 40 is electrically connected to CPU 30. The display circuit 40 controls the display screen 41 used to provide information to the personal digital media device user. The screen 41 can display one or more lines of alphanumeric information, but in a preferred embodiment, between one and three lines of alphanumeric information are displayed. Speaker 50 is electrically connected to CPU 30. Speaker 50 creates an audible sound according to one embodiment of this invention, as further explained herein. Input interface circuit 70 is electrically connected to CPU 30, microphone 72 and keyboard 71. The input interface circuit 70 receives data input from the personal digital media device user though the keyboard 71 and/or the microphone 72 and, in turn, conveys the data input to CPU 30. The input interface 70 and the display circuit 40 can be combined in other embodiments of this invention to permit data input via a touch screen (not depicted). In another embodiment, input interface 70 can receive sound information, such as a digital media device user's voice, through a microphone 72.

Radio frequency integrated circuit 20 is electrically connected to CPU 30. The radio frequency integrated circuit 20 facilitates wireless communication between the personal digital media device and another device, such as a personal computer or other host processing device, with its own radio frequency integrated circuit, each adapted to send and receive radio frequency transmissions from one another. The radio frequency integrated circuit 20 can be utilized to send and receive data, including, for example data corresponding to a serial identification number unique to the personal digital media device. In a preferred embodiment, the radio frequency integrated circuit 20 is of the type typically used by those having ordinary skill in the art for the purposes described herein, including: (1) an integrated CMOS RF receiver, combined with a dual 64-byte buffered framer block; (2) a self-contained, fast-hopping FSK data modem, optimized for use in the widely available 2.4 GHz ISM band; and (3) contains a frequency synthesizer, a power amplifier, a 12 MHz crystal oscillator, a demodulator, a modulator and an auto-Ack protocol engine; however, other radio frequency technology known to those having ordinary skill in the art, such as Bluetooth or Wi-Fi may be utilized as well.

The personal digital media device incorporates mass memory. The mass memory includes RAM 80 and ROM 90. In a preferred embodiment, the personal digital media device incorporates mass memory in CPU 30. In a preferred embodiment, hard disk drives and other more permanent storage devices are not utilized since those devices would increase the cost of the personal digital media device and such storage within the personal digital media device is otherwise unnecessary in view of the instant invention's utilization of a personal computer or other host processing device (such as a smart phone or other device programmed and configured to perform the functions of a personal computer herein described) to store certain information, as further explained herein. In one embodiment, RAM 80 is sufficient to store operating system 110 to control the operation of the personal digital media device. Any general-purpose operating system may be employed with a basic input/output system (“BIOS”) 100 for controlling the low-level operation of the personal digital media device. In a preferred embodiment, operating system 110, BIOS 100 are incorporated into CPU 30.

In other embodiments, the mass memory described above may incorporate computer-readable media, such as computer storage media commonly recognized by those having ordinary skill in the art, such as flash memory or any other medium which can be used to store the described information and can be accessed by the personal digital media device. The mass memory stores program code and data. Applications are loaded into the mass memory and run on operating system 110. Such applications may include user interface programs interfacing with database programs and the like. The mass memory is further configured to store information related to a serial identification number unique to the personal digital media device.

In one embodiment of the present invention, application software may include a graphical user interface prompting the personal digital media device user to complete the missing letters of a partially spelled word. In another embodiment of the present invention, application software may include a graphical user interface prompting the personal digital media device user to supply the sum, product, quotient, missing value or other input in response to a mathematical question. The personal digital media device user's input will be stored in the personal digital media device's mass memory within a database for subsequent use and access in accord with the invention further described herein. In another embodiment of the present invention, application software may include a graphical user interface prompting the personal digital media device user to supply one of a series of possible displayed selections. This may be commonly recognized as a multiple-choice question. In the case of the spelling, mathematical, general knowledge, logical operations or multiple-choice application embodiments herein described, the personal digital media device user's selections can be stored in the mass memory of the personal digital media device and/or sent via radio frequency to another device, such as a personal computer or other host processing device. Additionally, the other device, such as a personal computer, may utilize radio frequency transmissions to send subsequent application questions or other content to the personal digital media device user through the use of digital signals. In a preferred embodiment, the connection between the personal digital media device and the other device can be utilized along with application software on the other device programmed and configured to: (i) prepare reports summarizing a digital media device user's mastery of the learning content which may be, for example, sent to a parent via e-mail or accessed on the host processing device or through any browser connected device, such as another personal computer (other than the host processing device), a tablet personal computer, or a smart phone; (ii) permit a supervisor, such as a teacher or parent, to use the other device to monitor the personal digital media device user's progress through the learning content at any time; (iii) send text or audio messages from the other device to the personal digital media device; (iv) adjust the personal digital media device settings using the other device; and (v) add, delete or modify the learning content sent from the other device to the personal digital media device.

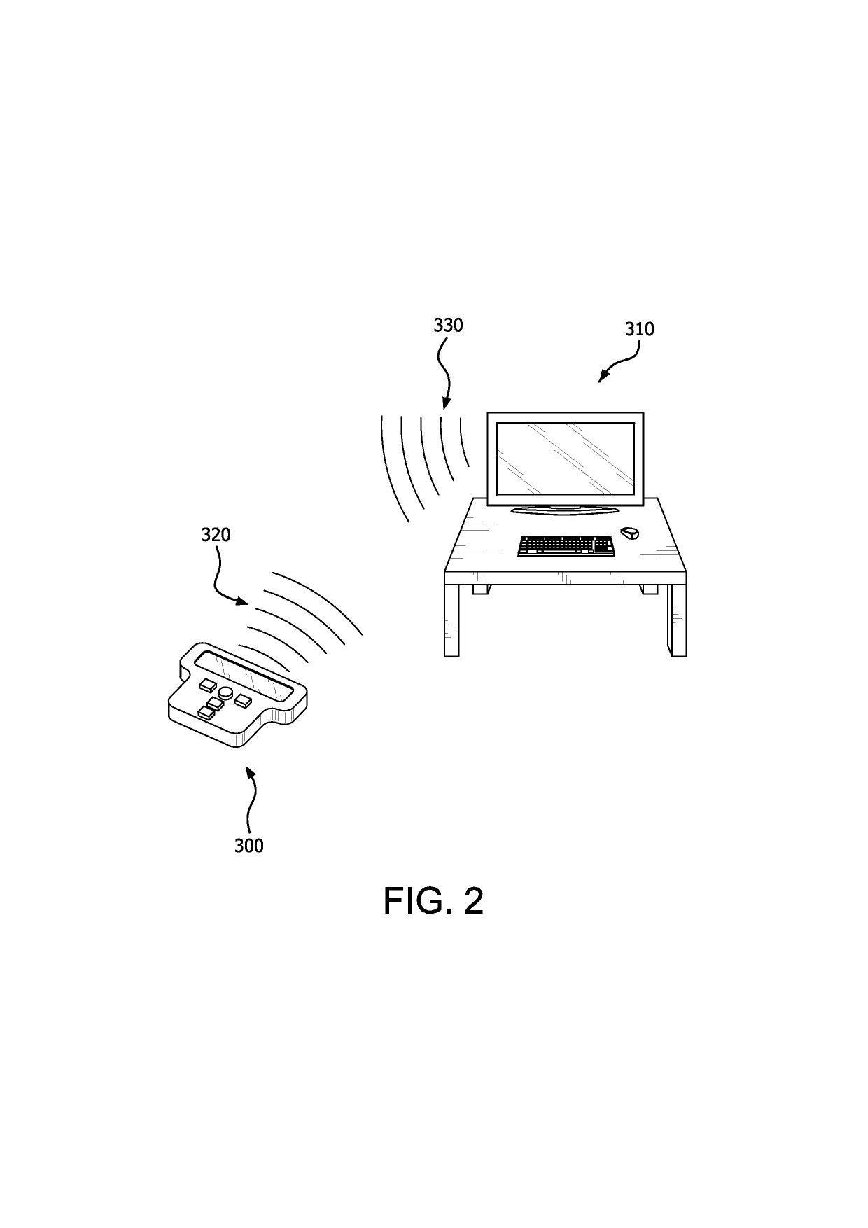

FIG. 2 shows a functional block diagram illustrating an environment for practicing the invention via a system for communication by and among a personal computer 310 and a personal digital media device 300 according to one embodiment of the instant invention. While this embodiment exemplifies the use of a personal computer, any host processing device, such as a smart phone or other device programmed and configured to perform the functions herein ascribed to a personal computer can be utilized. In this embodiment of the instant invention, a personal computer 310 is configured to perform actions which include the use of a radio frequency integrated circuit that is configured to send and receive content through the use of digital signals with a personal digital media device 300, as shown by radio frequency transmission 330. Personal computer 310 contains a database file and file system within its mass storage to store and recognize a unique serial identification number corresponding to a personal digital media device 300 where the unique serial identification number is transmitted by the personal digital media device 300 by radio frequency transmission of digital signals, as shown by radio frequency transmission 320. The personal digital media device 300 is also configured with a radio frequency integrated circuit (also referred to as a transmission signal module) that is configured to send and receive content with the personal computer 310 in the form of digital signals. The personal digital media device 300 is programmed with a unique serial identification number.

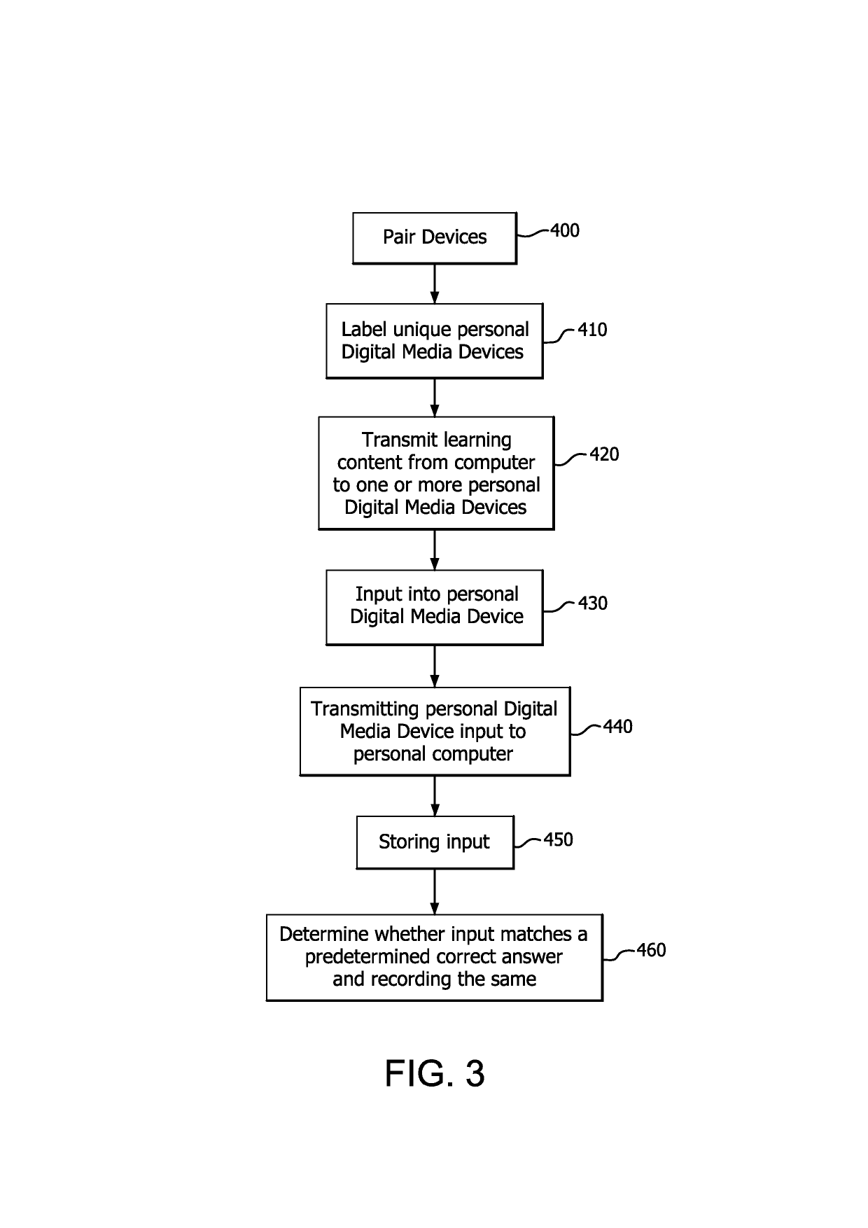

FIG. 3 is flow chart illustrating a system for carrying out one embodiment of the invention. According to this embodiment of the instant invention, a personal digital media device and a personal computer are paired in step 400 by sending and receiving content with radio frequency integrated circuits incorporated in the personal digital media device and a personal computer. The content is transmitted in the form of digital signals. While this embodiment exemplifies the use of a personal computer, any host processing device, such as a smart phone or other device programmed and configured to perform the functions herein ascribed to a personal computer can be utilized. The paring step 400 is completed after a processor in the personal computer is adapted to recognize the unique serial number associated with the personal digital media device. Accordingly, a plurality of personal digital media devices, each with their own unique serial number, can be independently paired with a personal computer.

Once the devices are paired, the personal computer user can label the paired personal digital media device (or devices) with a user-selected name in step 410. A personal computer user may, for example, desire to designate a user-selected name as a way to identify which personal digital media device may correspond to which personal digital media device user. By way of a more specific example, a parent with two children using personal digital media devices may label each device in step 410 with the name of the child utilizing each respective device. In an alternative embodiment, step 410 is not utilized.

Learning content, such as spelling questions, mathematical questions, general knowledge questions or logical operations questions, is transmitted in the form of digital signals from a personal computer to each paired personal digital media device with radio frequency integrated circuits incorporated in each paired personal digital media device and the personal computer at step 420.

In step 430, the paired personal digital media device user is provided with learning content displayed on the paired personal digital media device screen and/or broadcast through the personal digital media device's speaker and the personal digital media device user is prompted to input a response to the learning content.

In step 440, the paired personal digital media device user's input in response to learning content is transmitted as digital signals to a paired personal computer via radio frequency integrated circuits incorporated in the paired personal digital media device and the computer.

At step 450, the paired personal digital media device user's input is stored in a database file and file system within the mass memory of the personal digital media storage device. Additionally, or in the alternative, the digital media device user's input is stored in a database file and file system within the mass memory of the personal computer. In a preferred embodiment, the said input is stored exclusively on the personal computer in order to minimize the storage capacity and, in turn, the cost of the personal digital media device.

At step 460, a programmed personal computer and a processor adapted to the programmed personal computer's memory is used to compare the stored personal digital media device user's input to a pre-determined correct input pursuant to a programmed application and storing information with respect to whether or not the user's input matches the correct input for the respective prompt in a database file and file system.

By way of example, an application operating on a personal computer can contain learning content, such as a bank of questions appropriate to spelling, mathematical or other subjects. The question bank can be categorized by increasing levels of complexity. Questions can be sent according to the method herein described in step 420 from the personal computer to the personal digital media device. The personal digital media device user can respond to the transmitted spelling question, math question or multiple choice question, for example, in step 430. The personal digital media device user's input response can be transmitted back to the personal computer in step 440 through the use of a digital signal and then stored in the mass memory of the personal computer in step 450 (though, in other embodiments, it may also be optionally stored in the personal digital media device's mass memory). Based on the comparison performed in step 460, a personal digital media device user's response would be recorded in the personal computer's mass memory as either correct or incorrect. If the response is incorrect, the question can be flagged in the personal computer's mass memory. A parent operating the personal computer, for example, can see which questions the student has supplied correct answers for and which questions were incorrect. Questions with incorrect answers can be transmitted to the personal digital media device user for one or more subsequent attempts. In other embodiments, the application software will iterate to increasingly difficult categories of questions based on the student's mastery of less difficult material. In other embodiments, questions are not categorized, but instead offered at random or by some other ordering.

By way of a further example, the system herein described can be utilized by a teacher in a classroom environment. Each student can utilize his or her own personal digital media device. The teacher may quiz students by inputting pre-determined or teacher-created questions into a personal computer which can be sent to the students according to the system described herein and depicted in FIG. 3. Alternatively, according to another embodiment, students may send a signal using the personal digital media device, which would be received at a teacher's personal computer in a manner that utilizes the device labels herein described in order to identify which of a plurality of personal digital media device users sent the said signal as an alternative to the student raising his or her hand to attract the teacher's attention.

In another embodiment, the digital signal transmitted to the personal digital media device from a personal computer can signal a command to broadcast an audible sound (also referred to as an audible signal) from a speaker by way of a processor in the personal digital media device being further adapted to receive such data and broadcast such sound. In yet another embodiment, the speaker is used to broadcast the audible form of the learning content transmitted to the personal digital media device in addition to or as an alternative to displaying the learning content on the personal digital media device screen.

1. A personal digital media device comprising:
an integrated circuit that is configured to send and receive digital signals with a host processing device upon the host processing device's receipt of a serial identification number unique to the personal digital media device which is transmitted by digital signals from the personal digital media device to the host processing device;
a processor that performs actions, including:
using the integrated circuit to send and receive digital signals;
using the integrated circuit to send and receive the serial identification number unique to the digital media device; and
a display screen capable of displaying one or more lines of alphanumeric content.

2. The personal digital media device of claim 1 wherein the integrated circuit is a radio frequency integrated circuit.

3. The personal digital media device of claim 1 wherein the display screen is capable of displaying between one and three lines of alphanumeric content.

4. The personal digital media device of claim 1 wherein the host processing device is a personal computer.

5. The personal digital media device of claim 1 wherein the digital signals comprise content.

6. The personal digital media device of claim 5 wherein the content comprises data sent from application software operating on a host processing device.

7. The personal digital media device of claim 1 further comprising:
a speaker for broadcasting audible content; and
the processor being further adapted to receive data from a host processing device transmitted in the form of digital signals to the personal digital media device via the integrated circuit in the personal digital media device to signal the broadcast of audible content with the speaker.

8. The personal digital media device of claim 7 wherein the integrated circuit is a radio frequency integrated circuit.

9. The personal digital media device of claim 1 further comprising:
a speaker for broadcasting an audible signal; and
the processor being further adapted to receive data from a host processing device transmitted in the form of digital signals to the personal digital media device via the integrated circuit in the personal digital media device to signal the broadcast of an audible signal with the speaker.

10. The personal digital media device of claim 9 wherein the integrated circuit is a radio frequency integrated circuit.

11. The personal digital media device of claim 5 wherein the content comprises mathematical questions and answers.

12. The personal digital media device of claim 5 wherein the content comprises spelling questions and answers.

13. The personal digital media device of claim 5 wherein the content comprises general knowledge questions and answers.

14. The personal digital media device of claim 5 wherein the content comprises logical operations questions and answers.

15. The personal digital media device of claim 5 wherein the content comprises a plurality of possible selections of which the user of the personal digital media device may select one of the possible selections which is subsequently sent and received as content.

16. A system for communication between a host processing device and a personal digital media device, comprising:
a host processing device that is configured and programmed to perform actions including:
a radio frequency integrated circuit that is configured to send and receive digital signals encoding content with a personal digital media device;
a database file and file system to store and recognize a unique serial identification number corresponding to a personal digital media device where a unique serial identification number is transmitted as digital signals by the personal digital media device by radio frequency; and
the personal digital media device comprising:
a radio frequency integrated circuit that is configured to send and receive digital signals encoding content with a host processing device; and
a unique serial identification number.

17. The system of claim 16 wherein the host processing device is a personal computer.

18. A method of delivering content to a learner using a personal digital media device, comprising the steps of:
pairing a personal digital media device and a host processing device by sending and receiving digital signals encoding content with radio frequency integrated circuits incorporated in the personal digital media device and the host processing device;
adapting a host processing device processor to recognize a unique serial number associated with one or more paired personal digital media devices within the range of the radio frequency receiver on the host processing device;
permitting a host processing device user to label each recognized personal digital media device with a user-selected name corresponding to each unique serial number;
transmitting content encoded in digital signals from the host processing device to each paired personal digital media device with the radio frequency integrated circuits incorporated in each paired personal digital media device and the host processing device;
providing the paired personal digital media device with digital signals encoding learning content on the paired personal digital media device and prompting the paired personal digital media device user to input a response to the content;
transmitting digital signals encoding the paired personal digital media device user's input in response to content to the paired host processing device with the radio frequency integrated circuits incorporated in the paired personal digital media device and the host processing device;
storing the paired personal digital media device user's input in a database file and file system on a computer readable medium; and
using a programmed host processing device and a processor adapted to the host processing device's memory to compare the stored personal digital media device user's input to a pre-determined correct input and storing information with respect to whether or not the user's input matches the correct input for the respective prompt in a database file and file system within the host processing device's mass memory.

19. The method of claim 18 wherein the host processing device is a personal computer.

20. The method of claim 18 wherein the content is learning content.

21. The method of claim 18 further comprising the steps of:
using the programmed host processing device and the processor adapted to the host processing device's memory to utilize application software on the programmed host processing device programmed and configured to:
prepare reports summarizing a digital media device user's ratio of inputs matching pre-determined correct input to the number of inputs not matching pre-determined correct input;
send the said reports via e-mail to a designated recipient;
make the said reports accessible on the host processing device;
make the said reports accessible through any browser connected device;
prepare summaries showing the percentage of content prompts for which the personal digital media device user has submitted input;
send the said summaries via e-mail to a designated recipient;
make the said summaries accessible on the host processing device;
make the said summaries accessible on the host processing device through any browser connected device; and
add, delete or modify the content sent by digital signals from the host processing device to the personal digital media device.

22. The method of claim 21 wherein the browser connected device comprises a personal computer other than the host processing device.

23. The method of claim 21 wherein the browser connected device comprises a tablet personal computer other than the host processing device.

24. The method of claim 21 wherein the browser connected device comprises a smart phone other than the host processing device.
